(19) United States
(12) Patent Application Publication
(10) Pub. No.: US 2020/0076266 A1
(43) Pub. Date: Mar. 5, 2020

(54) FIXING STRUCTURE FOR COVER, AND GEARED MOTOR

(71) Applicant: NIDEC SANKYO CORPORATION, NAGANO (JP)

(72) Inventor: Takashi HIGUCHI, Nagano (JP)

(73) Assignee: NIDEC SANKYO CORPORATION, NAGANO (JP)

(21) Appl. No.: 16/605,809

(22) PCT Filed: Apr. 10, 2018
(86) PCT No.: PCT/JP2018/015049

§ 371 Date: Oct. 17, 2019

(30) Foreign Application Priority Data
Apr. 18, 2017 (JP) 2017-082152

(51) Int. Cl. H02K 5/04; H02K 7/116

(52) U.S. Cl. CPC H02K 5/04; H02K 7/116

(57) ABSTRACT

A fixing structure for a cover in which the cover is fixed to a support member and a geared motor are provided. A geared motor, wherein a gear cover includes a first cover member and a second cover member, the first cover member is supported on a third plate part and a first plate part of a frame, and the second cover member is supported on the first plate part. At a boundary between the first and second cover members, an end part of the first cover member and an end part of the second cover member are separated by a gap in a first direction, and on the boundary, there is provided an overlapping part in which one of the end part of the first cover member and the end part of the second cover member overlaps the other in a direction orthogonal to the first direction.

### TECHNICAL FIELD

The present invention relates to a fixing structure of a cover, and a geared motor structured to cover a gear transmission mechanism with a gear cover.

### BACKGROUND ART

In a geared motor structured to transmit rotation of a motor shaft of a motor main body to a rotary member through a gear transmission mechanism, a structure is adopted that a frame is provided at an end part on an output side of the motor main body and the rotary member is rotatably disposed between a first plate part and a second plate part of the frame (see Patent Literature 1).

### CITATION LIST

### Patent Literature

[Patent Literature 1] Japanese Patent Laid-Open No. 2009-124868

### SUMMARY

### Problems to be Solved by the Invention

The motor described in Patent Literature 1 has a problem, for example, that a foreign matter adheres to the gear transmission mechanism and thus, it is preferable to cover the gear transmission mechanism with a gear cover. In this case, the gear cover is fixed to a frame between the first plate part and the second plate part. Further, a through hole is formed in the gear cover and a rotation center shaft of the rotary member is penetrated through the through hole of the gear cover. Therefore, in a manufacturing process of the geared motor, it is required that, after the rotation center shaft of the rotary member has been penetrated through the through hole of the gear cover, the gear cover is disposed between the first plate part and the second plate part together with the rotary member and, after that, the cover is fixed to the frame (support member) and thus, installation of the cover requires much time and labor.

In view of the problem described above, an objective of the present invention is to provide a fixing structure of a cover capable of easily and appropriately fixing a cover to a support member and a geared motor.

### Means to Solve the Problems

In order to solve the above-mentioned problem, the present invention provides a fixing structure of a cover to a support member. The support member is provided with a first support part located on one side in a first direction with respect to the cover and a second support part located on one side in a second direction perpendicular to the first direction with respect to the cover, and the cover includes a first cover member supported by the first support part and the second support part and a second cover member supported by the second support part on the other side in the first direction with respect to the first cover member. A boundary part between the first cover member and the second cover member in the first direction is provided with an overlapped part where one of an end part on the other side in the first direction of the first cover member and an end part on the one side in the first direction of the second cover member is overlapped with the other of the end part on the other side in the first direction of the first cover member and the end part on the one side in the first direction of the second cover member in a direction perpendicular to the first direction.

In the present invention, the cover includes a first cover member and a second cover member, and the first cover member is supported by a first support part and a second support part of a support member, and the second cover member is supported by the second support part of the support member. Therefore, since the first cover member and the second cover member are respectively fixed to the support member, even in a case that a single piece of the cover is difficult to fix to the support member due to a structural problem of a portion where the cover is provided, the cover can be fixed to the support member easily. Further, in a state that the first cover member and the second cover member have been fixed to the support member, even in a case that a gap space separating the first cover member from the second cover member is formed in the first direction due to an influence of dimensional accuracy and the like of the first cover member and the second cover member, an overlapped part is provided where one of an end part on the other side in the first direction of the first cover member and an end part on the one side in the first direction of the second cover member are overlapped with the other in a direction perpendicular to the first direction and thus, for example, a situation that the gap space is left in an opened state does not occur, and the cover can be fixed to the support member appropriately.

In the present invention, it may be structured that the end part on the other side in the first direction of the first cover member is provided with a projected part which is projected to the other side in the first direction and has a plate thickness thinner than that of an adjacent portion to the projected part on the one side in the first direction, the end part on the one side in the first direction of the second cover member is provided with a thin plate part having a plate thickness thinner than that of an adjacent portion to the thin plate part on the other side in the first direction, and the projected part and the thin plate part are overlapped with each other to structure the overlapped part. According to this structure, the overlapped part can be structured thinly.

In the present invention, it may be structured that, in the boundary part, the first cover member and the second cover member are separated from each other in the first direction through a gap space, and the gap space is closed by the overlapped part. According to this structure, when the first cover member and the second cover member are to be fixed to the support member, a situation is hard to occur that the first cover member and the second cover member are interfered with each other in the first direction due to an influence of dimensional accuracy and the like of the first cover member and the second cover member. Further, even when vibration is transmitted to the cover, a situation is hard to occur that the first cover member and the second cover member are collided with each other in the first direction to generate noise. Further, a gap space formed in the boundary part between the first cover member and the second cover member is closed by the overlapped part of the first cover member with the second cover member and thus, a foreign matter is hard to enter into an inner side of the cover through the gap space.

In the present invention, it may be structured that one of the first cover member and the support member is provided with an urging force generation part structured to generate an urging force urging the cover in an inclined direction which is inclined with respect to both of the other side in the first direction and the one side in the second direction when the first cover member is pressed against the first support part, and the second support part is provided with a first abutting part which is abutted with the first cover member from the one side in the second direction, and a second abutting part which is abutted with the first cover member from the other side in the first direction. According to this embodiment, when the first cover member is pressed toward the first support part of the support member, the urging force generation part urges the first cover member in an inclined direction which is inclined with respect to both of the other side in the first direction and one side in the second direction. As a result, the first cover member is elastically abutted with the first support part and the second abutting part provided in the second support part is elastically abutted with the cover from the other side in the first direction. Therefore, the first cover member can be fixed to the first support part and the second support part by a simple operation that the first cover member is pressed toward the first support part of the support member. Further, the first cover member is elastically fixed to the first support part and the second support part and thus rattling is hard to occur.

In the present invention, it may be structured that the urging force generation part is a first flexible plate part structured to be resiliently bent to generate the urging force with an inclined face inclined with respect to both of the first direction and the second direction as a contact face of the first cover member with the first support part when the first cover member is pressed against the first support part. According to this structure, the urging force generation part structured to generate an urging force in an appropriate predetermined direction can be structured by the first flexible plate part.

In the present invention, it may be structured that the first flexible plate part is formed in the first cover member so as to extend in the second direction with a free end facing the other side in the second direction, the first flexible plate part is formed with the inclined face so as to face the inclined direction which is inclined with respect to both of the one side in the first direction and the other side in the second direction, and the first flexible plate part is resiliently bent to the other side in the first direction to generate the urging force when the first cover member is pressed against the first support part. According to this embodiment, the urging force generation part can be structured by using the first flexible plate part provided in the first cover member in itself and thus, another member for structuring the urging force generation part is not required.

In the present invention, it may be structured that the inclined face is formed in a protruding shaped contact part which is protruded toward the one side in the first direction from the first flexible plate part, and the first support part is provided with an opening part which is opened toward the other side in the first direction and, when the first cover member is pressed against the first support part, the protruding shaped contact part is fitted to the opening part, and an opening edge on the other side in the first direction of the opening part is abutted with the inclined face. According to this structure, a large gap space can be prevented from being provided between the first support part and the first cover member.

In the present invention, it may be structured that the second abutting part is provided with an inner circumferential surface of a hole formed in the second support part so that a protruded part formed in the first cover member is fitted, or an outer peripheral face of a protruded part formed in the second support part so as to be fitted to a hole formed in the first cover member. According to this structure, the second abutting part can be structured in a simple structure.

In the present invention, it may be structured that the first cover member is provided with a first hook which is protruded toward the other side in the second direction and engaged with the second support part from the one side in the second direction. According to this structure, even when a large force is applied to the first cover member, the first cover member can be restrained from detaching to the other side in the second direction. Further, the first cover member is fixed by the urging force generation part, the first abutting part and the second abutting part and thus, even when a gap space between the first hook and the second support part is large, rattling is hard to occur. Therefore, a large force is not required for engagement of the first hook and thus, assembling work can be performed efficiently.

In the present invention, it may be structured that the second cover member is provided with a second hook which is protruded toward the other side in the second direction and is engaged with the second support part from the one side in the second direction, and a second flexible plate part which is elastically abutted with the second support part from the other side in the second direction. According to this structure, the second cover member is fixed to the second support part without rattling.

In the present invention, it may be structured that an engaging part positioning the cover in a third direction perpendicular to both of the first direction and the second direction is structured by an engagement protruded part, which is formed in one of the first support part and the first cover member, and an engagement recessed part which is formed in the other and is fitted with the engagement protruded part. According to this structure, the first cover member can be surely positioned in the third direction.

The fixing structure of a cover in accordance with the present invention may be used in a geared motor. In this case, the geared motor includes a motor main body whose a motor axial line is extended toward the other side in the second direction, a frame provided with a first plate part which is fixed to an end part on the other side in the second direction of the motor main body, a second plate part facing the first plate part on the other side in the second direction, and a third plate part which connects the first plate part and the second plate part on the one side in the first direction, a rotary member which is disposed between the first plate part and the second plate part, a gear transmission mechanism structured to transmit rotation of a motor shaft of the motor main body to the rotary member, and a gear cover which is fixed to the frame so as to cover the gear transmission mechanism between the first plate part and the second plate part. The frame is the support member, the gear cover is the cover, the third plate part is the first support part, and the first plate part is the second support part and, in the boundary part, a through hole through which a rotation center shaft of the rotary member is penetrated is structured of a first cut-out part, which is formed at an end part on the other side in the first direction of a first end plate part of the first cover member facing the first plate part, and a second cut-out part which is formed at an end part on the one side in the first direction of a second end plate part of the second cover member facing the first plate part. According to this structure, even in a case that the rotary member is protruded from the cover, the cover can be easily fixed to the frame so as to cover the gear transmission mechanism. Further, rattling is hard to occur between the frame and the gear cover and thus, even when vibration is occurred by rotation of the motor main body, generation of noise can be restrained.

In the present invention, it may be structured that the gear transmission mechanism includes a fixed shaft whose both ends are held by the first end plate part and the first plate part, and a gear rotatably supported by the rotary member. According to this structure, the fixed shaft can be held by utilizing the first cover member.

### Effects of the Invention

In the present invention, the cover includes a first cover member and a second cover member, and the first cover member is supported by a first support part and a second support part of a support member, and the second cover member is supported by the second support part of the support member. Therefore, since the first cover member and the second cover member are respectively fixed to the support member, even in a case that a single piece of a cover is difficult to fix to the support member due to a structural problem of a portion where the cover is provided, the cover can be fixed to the support member easily. Further, in a state that the first cover member and the second cover member have been fixed to the support member, even in a case that a gap space separating the first cover member from the second cover member is formed in the first direction due to an influence of dimensional accuracy and the like of the first cover member and the second cover member, an overlapped part is provided where one of an end part on the other side in the first direction of the first cover member and an end part on the one side in the first direction of the second cover member are overlapped with the other in a direction perpendicular to the first direction and thus, for example, a situation that the gap space is left in an opened state does not occur, and the cover can be fixed to the support member appropriately.

### BRIEF DESCRIPTION OF THE DRAWINGS

FIG. 1 is a perspective view showing an embodiment of a geared motor to which the present invention is applied.

FIG. 2 is a side view showing the geared motor in FIG. 1 which is viewed from one side in a third direction.

FIG. 3 is an exploded perspective view showing a state that a second cover member of a gear cover is detached from the state shown in FIG. 1.

FIG. 4 is an exploded perspective view showing a state that a first cover member of the gear cover is further detached from the state shown in FIG. 3.

FIG. 5 is an exploded perspective view showing a gear transmission mechanism of the geared motor shown in FIG. 1.

FIG. 6 is a perspective view showing a first cover member in FIG. 1 which is viewed from the other side in a first direction and from one side in a second direction.

FIG. 7 is a perspective view showing a state that a gear cover is fixed to a frame in the geared motor shown in FIG. 1 which is viewed from one side in the first direction and from one side in the second direction.

FIG. 8 is a perspective view showing a state that the gear cover is detached in the state shown in FIG. 7.

FIG. 9 is an explanatory view showing a fixing structure of the gear cover to a frame shown in FIG. 1.

FIG. 10 is a perspective view showing a second cover member in FIG. 1 which is viewed from the other side in the first direction and from the other side in the second direction.

FIG. 11 is a side view showing the second cover member in FIG. 1 which is viewed from the other side in the first direction.

FIG. 12 is a “Y-Z” cross-sectional view showing a state that the gear cover and the like are cut at a position passing through a first protruded part of the gear cover in the state shown in FIG. 1.

FIG. 13 is a “Y-Z” cross-sectional view showing a state that the second cover member and the like are cut at a position passing through a second flexible plate part of the second cover member in the state shown in FIG. 1.

### DESCRIPTION OF EMBODIMENTS

A fixing structure of a cover to which the present invention is applied will be described below with reference to the accompanying drawings. In the following descriptions, as a fixing structure of a cover to a support member, an example in which a gear cover 6 (cover) is fixed to a frame 3 (support member) of a geared motor 1 will be mainly described.

In a geared motor 1 described below, a rotation center axial line of a motor shaft 50 of a motor main body 10 and a rotation center axial line of a rotary member 4 are parallel to each other, and both of the rotation center axial lines can be considered as a motor axial line. In the following descriptions, the rotation center axial line of the rotary member 4 is described as a motor axial line “L”. Further, in the following descriptions, in a direction where the motor axial line “L” is extended (motor axial line “L” direction), one side to which a motor shaft 50 is protruded from the motor main body 10 is referred to as an output side “L1”, and an opposite side (the other side) to the side where the motor shaft 50 is protruded from the motor main body 10 is referred to as an anti-output side “L2”. Further, in directions perpendicular to the motor axial line “L”, a direction perpendicular to a third plate part 33 of a frame 3 is defined as a first direction “X”, a direction where the motor axial line “L” is extended is defined as a second direction “Z”, and a direction perpendicular to the first direction “X” and the second direction “Z” is defined as a third direction “Y”. Further, in the first direction “X”, a side where the third plate part 33 is located in the frame 3 is defined as one side “X1”, and a side to which the first plate part 31 and the second plate part 32 are protruded from the third plate part 33 is defined as the other side “X2”. Further, in the second direction “Z”, the anti-output side “L2” is defined as one side “Z1”, and the output side “L1” is defined as the other side “Z2”. Further, in the following descriptions, “Y1” is indicated to one side in the third direction “Y”, and “Y2” is indicated to the other side.

### Entire Structure

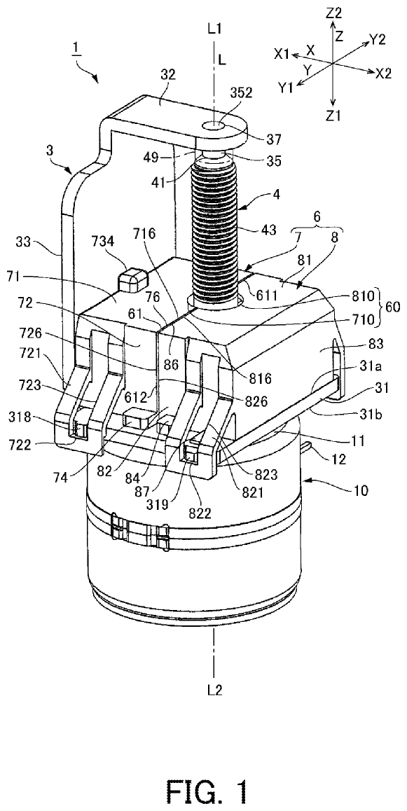

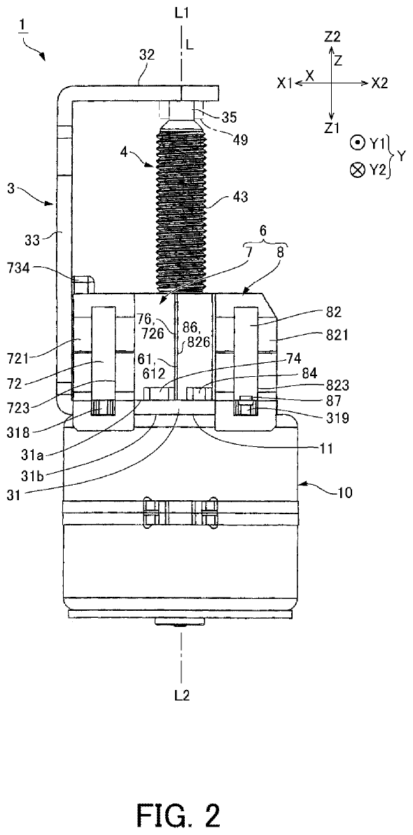

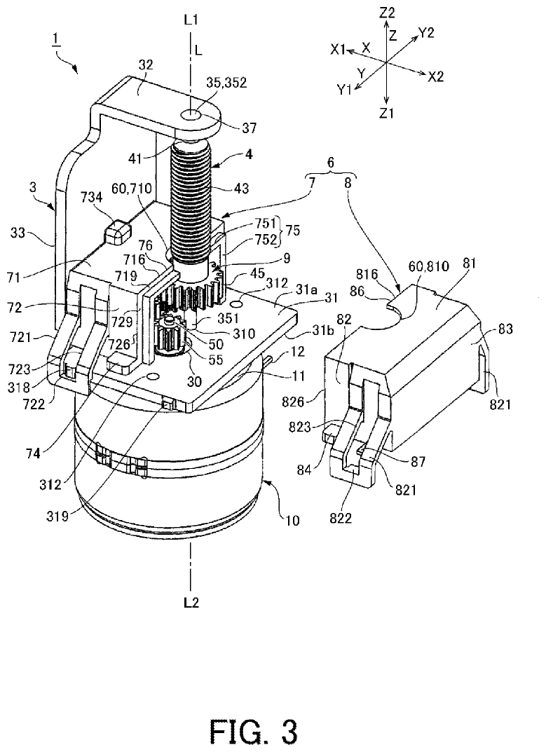

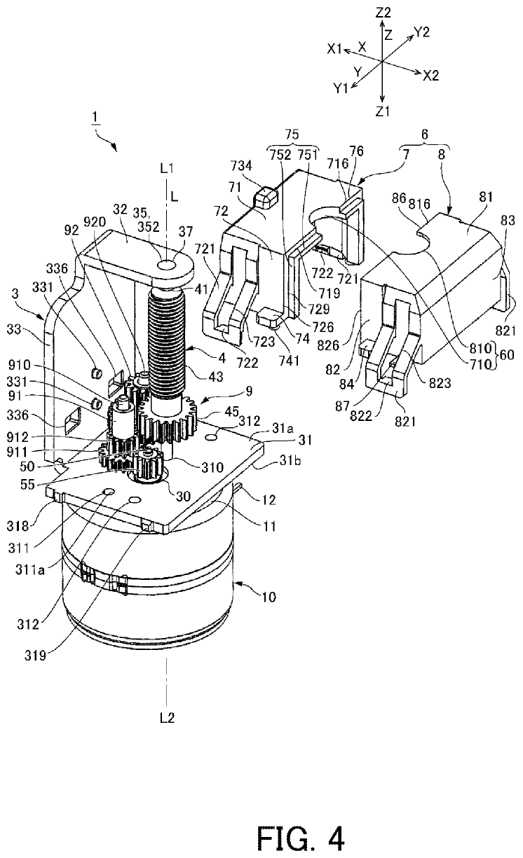

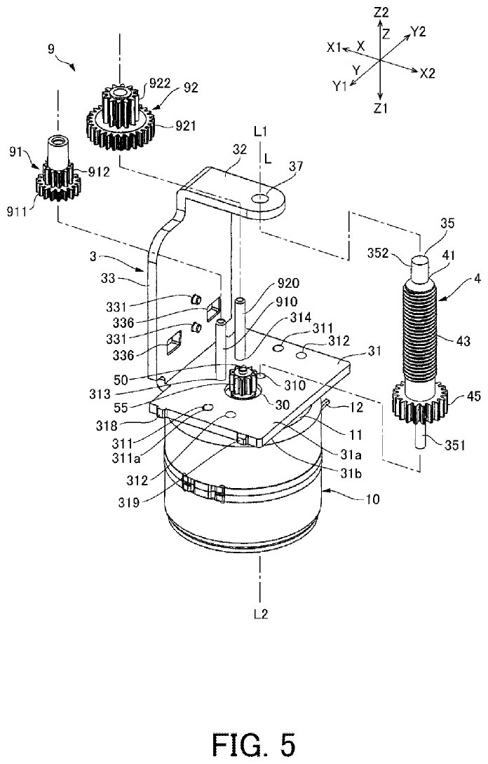

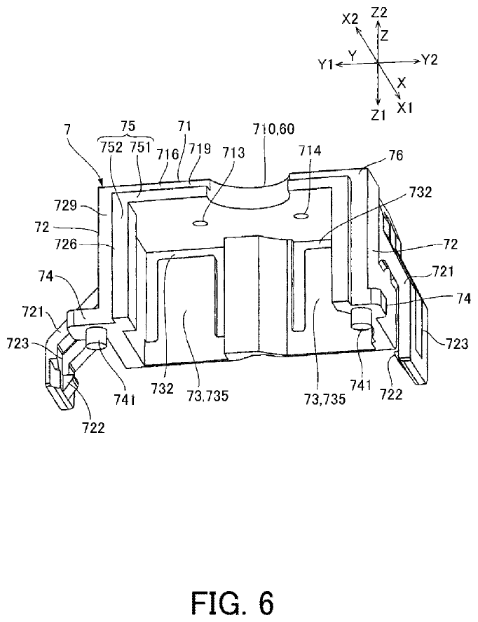

FIG. 1 is a perspective view showing an embodiment of a geared motor 1 to which the present invention is applied. FIG. 2 is a side view showing the geared motor 1 shown in FIG. 1 which is viewed from one side “Y1” in the third direction “Y”. FIG. 3 is an exploded perspective view showing a state that a second cover member 8 of a gear cover 6 is detached from the state shown in FIG. 1. FIG. 4 is an exploded perspective view showing a state that a first cover member 7 of the gear cover 6 is further detached from the state shown in FIG. 3. FIG. 5 is an exploded perspective view showing a gear transmission mechanism 9 of the geared motor 1 shown in FIG. 1. FIG. 6 is a perspective view showing a first cover member 7 in FIG. 1 which is viewed from the other side “X2” in the first direction “X” and from one side “Z1” in the second direction “Z”.

As shown in FIGS. 1, 2, 3 and 4, a geared motor 1 includes a motor main body 10 and a frame 3 which is fixed to an end part 11 on one side (output side “L1”) in a motor axial line “L” direction of the motor main body 10. The frame 3 is provided with a first plate part 31 fixed to an end part 11 on the output side “L1” of the motor main body 10 by a method such as welding, a second plate part 32 facing the first plate part 31 on the output side “L1”, and a third plate part 33 connecting the first plate part 31 with the second plate part 32 on one side “X1” in the first direction “X”. A power supply part 12 is provided in a side face of the motor main body 10. A hole 30 is formed in the first plate part 31, and a motor shaft 50 of the motor main body 10 is protruded to the output side “L1” from the first plate part 31 through the hole 30. A motor pinion 55 is fixed to a portion of the motor shaft 50 which is protruded to the output side “L1” from the first plate part 31.

Further, the geared motor 1 includes a rotary member 4 disposed between the first plate part 31 and the second plate part 32, a gear transmission mechanism 9 structured to transmit rotation of the motor shaft 50 of the motor main body 10 to the rotary member 4, and a gear cover 6 which covers the gear transmission mechanism 9 from the output side “L1” between the first plate part 31 and the second plate part 32. The gear cover 6 is fixed to the frame 3. As described in detail below, the gear cover 6 includes a first cover member 7 and a second cover member 8 disposed on the other side “X2” in the first direction “X” with respect to the first cover member 7.

As shown in FIGS. 4 and 5, a rotation center shaft 35 of the rotary member 4 is provided between the first plate part 31 and the second plate part 32. In this embodiment, the rotation center shaft 35 is a fixed shaft and rotatably supports the rotary member 4 around the motor axial line “L”. An end part 351 on the anti-output side “L2” of the rotation center shaft 35 is held in a state that the end part 351 is fitted to a shaft hole 310 formed in the first plate part 31. An end part 352 on the output side “L1” of the rotation center shaft 35 is fixed to the second plate part 32 in a state that the end part 352 is fitted to a hole 37 formed in the second plate part 32. When the end part 352 is to be fixed, a method such as welding, caulking or adhesion may be adopted.

The rotary member 4 is a shaft-shaped member which is formed with a shaft hole 41 through which the rotation center shaft 35 is penetrated, and its outer peripheral portion is formed with a gear part 45 and a spiral groove 43 in this order from the anti-output side “L2” to the output side “L1”. In this embodiment, the rotary member 4 is structured with the spiral groove 43 as a feed screw or a worm gear. The rotary member 4 is made of resin and the gear part 45 and the spiral groove 43 are integrally formed with each other. An outer diameter of a portion of the rotation center shaft 35 supporting a portion where the spiral groove 43 is formed is larger than an outer diameter of a portion where the gear part 45 is formed. However, the entire rotation center shaft 35 may be formed so as to have the same outer diameter (thickness). In this embodiment, movement in the motor axial line “L” direction of the rotary member 4 with respect to the rotation center shaft 35 is restricted by a thrust bearing 49 (see FIGS. 1 and 2) shown by the alternate long and short dash line in FIGS. 1 and 2.

In the rotary member 4, the gear part 45 is mechanically connected with the motor pinion 55 through a first gear 91 and a second gear 92, and the gear transmission mechanism 9 is structured of the motor pinion 55, the first gear 91, the second gear 92 and the gear part 45. Therefore, rotation of the motor shaft 50 is decelerated and transmitted to the rotary member 4 through the gear transmission mechanism 9. The first gear 91 is a composite gear in which a large diameter gear 911 engaged with the motor pinion 55 and a small diameter gear 912 whose outer diameter is smaller than that of the large diameter gear 911 are integrally and coaxially formed with each other. The second gear 92 is a composite gear in which a large diameter gear 921 engaged with the small diameter gear 912 of the first gear 91 and a small diameter gear 922 whose outer diameter is smaller than that of the large diameter gear 921 are integrally and coaxially formed with each other. The small diameter gear 922 is engaged with the gear part 45 of the rotary member 4.

The first gear 91 is rotatably supported by a support shaft 910 whose end part on one side “Z1” in the second direction “Z” is held by a shaft hole 313 of the first plate part 31. The second gear 92 is rotatably supported by a support shaft 920 whose end part on one side “Z1” in the second direction “Z” is held by a shaft hole 314 of the first plate part 31. In this embodiment, an end part on the other side “Z2” in the second direction “Z” of the support shaft 910 is held by a shaft hole 713 formed in the first end plate part 71 of the first cover member 7 shown in FIG. 6. Further, an end part on the other side “Z2” in the second direction “Z” of the support shaft 920 is held by a shaft hole 714 formed in the first end plate part 71 of the first cover member 7 shown in FIG. 6.

### Structure of Gear Cover 6

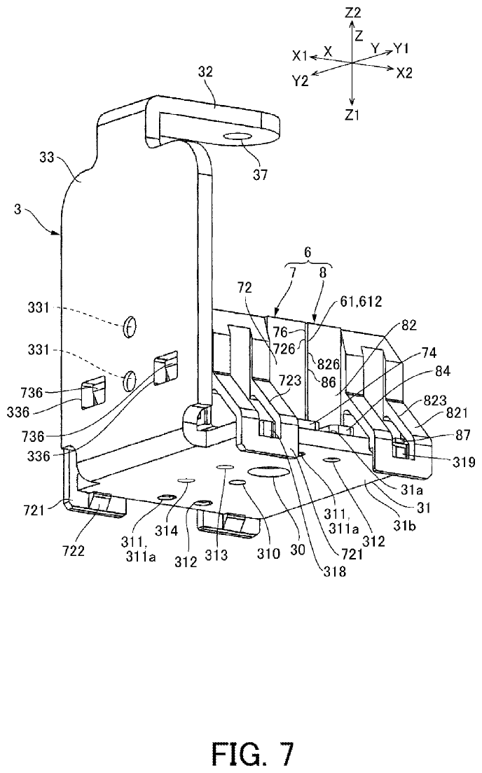

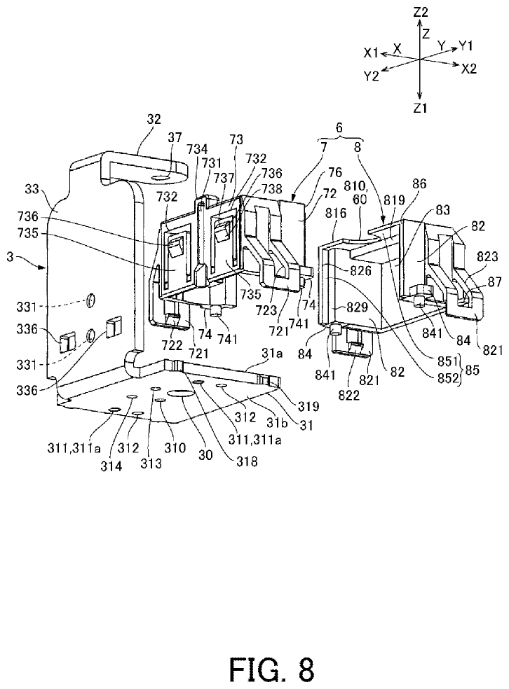

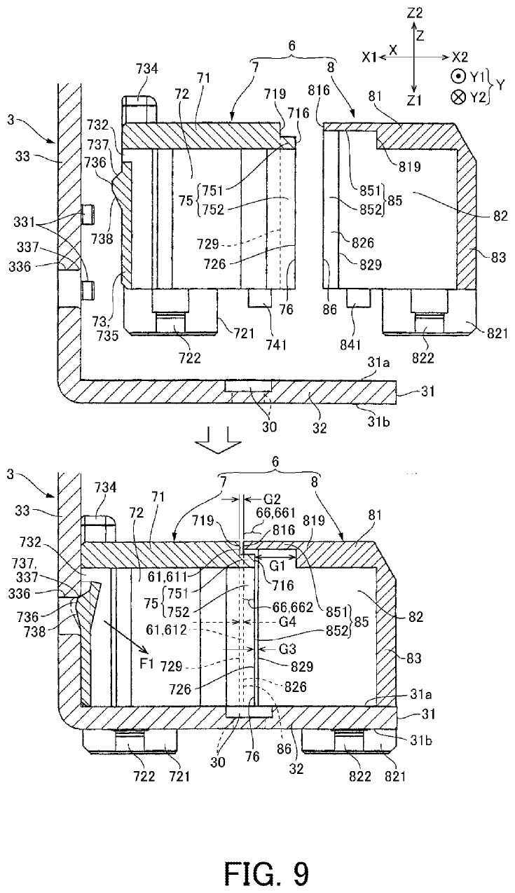

FIG. 7 is a perspective view showing a state that the gear cover 6 is fixed to the frame 3 in the geared motor 1 shown in FIG. 1 which is viewed from one side “X1” in the first direction “X” and from one side “Z1” in the second direction “Z”. FIG. 8 is a perspective view showing a state that the gear cover 6 is detached in the state shown in FIG. 7. FIG. 9 is an explanatory view showing a fixing structure of the gear cover 6 to the frame 3 shown in FIG. 1 and is an “X-Z” cross-sectional view showing a state that the gear cover 6 and the like are cut at a position passing through a first flexible plate part 735 of the first cover member 7. An upper figure in FIG. 9 shows a state before the gear cover 6 is fixed to the frame 3, and its lower side figure shows a state after the gear cover 6 has been fixed to the frame 3.

As shown in FIGS. 3, 4, 7, 8 and 9, the gear cover 6 includes the first cover member 7 which covers a portion of the gear transmission mechanism 9 disposed on one side “X1” in the first direction “X”, and the second cover member 8 which covers a portion of the gear transmission mechanism 9 disposed on the other side “X2” in the first direction “X”. The first cover member 7 is provided with a first end plate part 71 facing the first plate part 31 on the other side “Z2” in the second direction “Z”, first side plate parts 72 which are bent from both end parts in the third direction “Y” of the first end plate part 71 to one side “Z1” in the second direction “Z”, and a second side plate part 73 which is bent from an end part on one side “X1” in the first direction “X” of the first end plate part 71 to one side “Z1” in the second direction “Z”. The other side “X2” in the first direction “X” of the first cover member 7 is formed to be an open end.

The second cover member 8 is provided with a second end plate part 81 facing the first plate part 31 on the other side “Z2” in the second direction “Z”, third side plate parts 82 which are bent from both end parts in the third direction “Y” of the second end plate part 81 to one side “Z1” in the second direction “Z”, and a fourth side plate part 83 which is bent from an end part on the other side “X2” in the first direction “X” of the second end plate part 81 to one side “Z1” in the second direction “Z”. The one side “X1” in the first direction “X” of the second cover member 8 is formed to be an open end. The second cover member 8 is disposed at a position adjacent to the other side “X2” in the first direction “X” with respect to the first cover member 7. Therefore, the gear cover 6 covers the gear transmission mechanism 9 from the other side “Z2” in the second direction “Z”, from both sides in the first direction “X”, and from both sides in the third direction “Y”.

In a boundary part 61 between an end part 76 on the other side “X2” in the first direction “X” of the first cover member 7 and an end part 86 on one side “X1” in the first direction “X” of the second cover member 8, the rotation center shaft 35 and the rotary member 4 are penetrated through a through hole 60 which is opened in the boundary part 61 between the first end plate part 71 and the second end plate part 81 and are protruded to the output side “L1” from an inner side of the gear cover 6. Therefore, a first cut-out part 710 in a semicircular shape is formed at an end part 716 on the other side “X2” in the first direction “X” of the first end plate part 71 of the first cover member 7, and a second cut-out part 810 in a semicircular shape is formed at an end part 816 on one side “X1” in the first direction “X” of the second end plate part 81 of the second cover member 8. The circular through hole 60 is structured of the first cut-out part 710 and the second cut-out part 810.

In the gear cover 6 structured as described above, as described below, the first cover member 7 is supported by the third plate part 33 of the frame 3 located on one side “X1” in the first direction “X” with respect to the gear cover 6 and by the first plate part 31 of the frame 3 located on one side “Z1” in the second direction “Z” with respect to the gear cover 6. Further, the second cover member 8 is supported by the first plate part 31 located on one side “Z1” in the second direction “Z” with respect to the gear cover 6.

### Detailed Structure of Frame 3

As shown in FIGS. 4, 8 and 9, the first plate part 31 of the frame 3 is formed with first holes 311 on both sides in the third direction “Y” with respect to the hole 30, and second holes 312 are formed on the other side “X2” in the first direction “X” with respect to the respective two first holes 311. In this embodiment, the first hole 311 and the second hole 312 are through holes. The first plate part 31 of the frame 3 is formed with protruded parts 318 which are protruded to both sides in the third direction “Y”, and protruded parts 319 protruded to both sides in the third direction “Y” are also formed on the other side “X2” in the first direction “X” with respect to the protruded parts 318.

The third plate part 33 of the frame 3 is formed with an engagement protruded part 331 at two positions at a substantially center in the third direction “Y” and separated from each other in the second direction “Z”. In this embodiment, the engagement protruded part 331 is formed by press working to the third plate part 33. Therefore, a face on one side “X1” in the first direction “X” of the third plate part 33 is formed with recessed parts which are recessed when the engagement protruded parts 331 have been formed.

The third plate part 33 of the frame 3 is formed with opening parts 336 in a quadrangular shape on both sides in the third direction “Y” with respect to the engagement protruded part 331 located on one side “Z1” in the second direction “Z” of the two engagement protruded parts 331. As shown in FIG. 9, the opening part 336 is formed so that an edge located on the other side “Z2” in the second direction “Z” of the opening edges on the other side “X2” in the first direction “X” is formed to be an inclined face 337 which is inclined with respect to both of the other side “X2” in the first direction “X” and the one side “Z1” in the second direction “Z”.

### Detailed Structure of First Cover Member 7

As shown in FIGS. 4, 6 and 8, the two first side plate parts 72 of the first cover member 7 located on both sides in the third direction “Y” are formed with two flange parts 74 at end parts on the other side “X2” in the first direction “X” so as to protrude from the first side plate parts 72 toward both sides in the third direction “Y”. Each of the two flange parts 74 is formed with a first protruded part 741 in a round bar shape which is protruded to one side “Z1” in the second direction “Z”.

Further, each of the two first side plate parts 72 located on both sides in the third direction “Y” is formed with a first hook 721 which is obliquely protruded to one side “Z1” in the second direction “Z” and then extended to one side “Z1” in the second direction “Z”. An end part on one side “Z1” in the second direction “Z” of the first hook 721 is formed with a first nail part 722 which is protruded to an inner side. The first hook 721 is provided with a frame shape which is formed with a groove 723 extended in the second direction “Z” at a center position in the first direction “X”.

A substantially center portion in the third direction “Y” of the second side plate part 73 is formed with an engagement recessed part 731 in a groove shape which is extended in the second direction “Z” at a position overlapping with the two engagement protruded parts 331 of the frame 3. In this embodiment, an end part on the other side “Z2” in the second direction “Z” of the engagement recessed part 731 is formed to a position of a protruded part 734 formed in the first end plate part 71.

The first flexible plate part 735 is formed in the second side plate part 73 on both sides in the third direction “Y” with respect to the engagement recessed part 731 so that three sides of the first flexible plate part 735 are cut out in a groove 732 shape while leaving an end part on one side “Z1” in the second direction “Z”. The first flexible plate part 735 is formed in the first cover member 7 so as to be extended in the second direction “Z” with its free end being directed toward the other side “Z2” in the second direction “Z”. The first flexible plate part 735 is structured so that the other side “Z2” in the second direction “Z” of the first flexible plate part 735 is elastically deformable in the first direction “X”.

A protruding shaped contact part 736 protruded to one side “X1” in the first direction “X” is formed on a face on one side “X1” in the first direction “X” of the first flexible plate part 735 in the vicinity of an end part on the other side “Z2” in the second direction “Z”. An end part on the other side “Z2” in the second direction “Z” of the protruding shaped contact part 736 is formed to be an inclined face 737 which is inclined with respect to both of one side “X1” in the first direction “X” and the other side “Z2” in the second direction “Z”. In this embodiment, an end part on one side “Z1” in the second direction “Z” of the protruding shaped contact part 736 is also formed to be an inclined face 738.

In the first cover member 7 structured as described above, an inner face side of an end part 76 on the other side “X2” in the first direction “X” is formed with a projected part 75 which is projected toward the other side “X2” in the first direction “X” with a plate thickness thinner than that of a portion adjacent to one side “X1” in the first direction “X”. In this embodiment, the projected part 75 is formed in each of the end parts 716 and 726 on the other side “X2” in the first direction “X” of the first end plate part 71 and the first side plate parts 72. Therefore, the first cover member 7 is formed with a first projected part 751 which is the projected part 75 formed in the first end plate part 71, and second projected parts 752 which are the projected parts 75 formed in the first side plate parts 72 of the first cover member 7. Accordingly, outer face sides of the first end plate part 71 and the first side plate parts 72 are formed with first step parts 719 and 729 which face the other side “X2” in the first direction “X” in a root portion of the projected part 75 (first projected part 751 and second projected parts 752). In this embodiment, the first projected part 751 and the second projected parts 752 are connected with each other. Further, dimensions (width) in the first direction “X” of the first projected part 751 and the second projected parts 752 are equal to each other.

### Detailed Structure of Second Cover Member 8

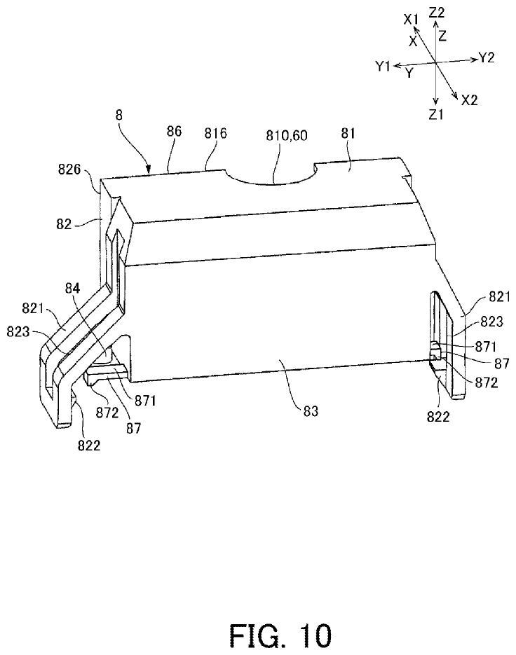

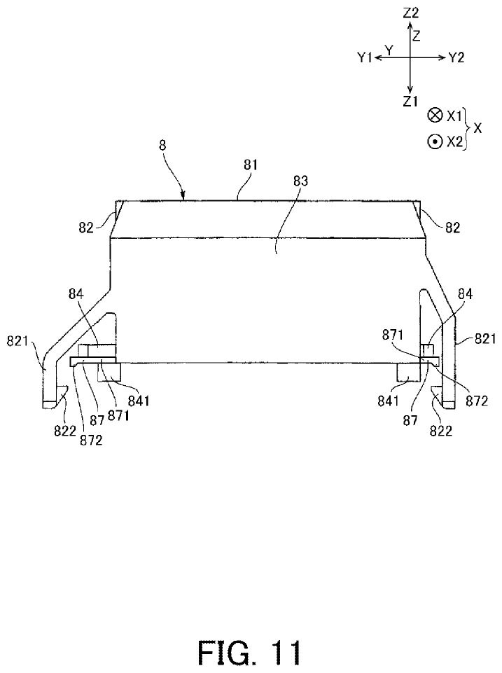

FIG. 10 is a perspective view showing the second cover member 8 in FIG. 1 which is viewed from the other side “X2” in the first direction “X” and from the other side “Z2” in the second direction “Z”. FIG. 11 is a side view showing the second cover member 8 in FIG. 1 which is viewed from the other side “X2” in the first direction “X”.

As shown in FIGS. 4, 8 and 10, the two third side plate parts 82 of the second cover member 8 located on both sides in the third direction “Y” are formed with two flange parts 84 at end parts on one side “X1” in the first direction “X” so as to protrude from the third side plate parts 82 toward both sides in the third direction “Y”. Each of the two flange parts 84 is formed with a second protruded part 841 in a round bar shape which is protruded to one side “Z1” in the second direction “Z”.

Further, each of the two third side plate parts 82 located on both sides in the third direction “Y” is formed with a second hook 821 which is obliquely protruded to one side “Z1” in the second direction “Z” and then extended to one side “Z1” in the second direction “Z”. An end part on one side “Z1” in the second direction “Z” of the second hook 721 is formed with a second nail part 822 which is protruded to an inner side. The second hook 821 is provided with a frame shape which is formed with a groove 823 extended in the second direction “Z” at a center position in the first direction “X”.

As shown in FIGS. 10 and 11, each of the two third side plate parts 82 located on both sides in the third direction “Y” is formed with a second flexible plate part 87 which is protruded from an end part on one side “Z1” in the second direction “Z” toward an outer side. The second flexible plate part 87 is provided with an arm part 871 which is protruded in the third direction “Y” from the third side plate part 82 toward the groove 823 of the second hook 821, and a tip end part 872 which is protruded to one side “Z1” in the second direction “Z” from the arm part 871. The arm part 871 is elastically deformable with respect to the second direction “Z”. Further, as shown in FIG. 11, the tip end part 872 is protruded to one side “Z1” in the second direction “Z” with respect to end parts on one side “Z1” in the second direction “Z” of the third side plate part 82 and the fourth side plate part 83.

In the second cover member 8 structured as described above, an outer face side of the end part 86 on one side “X1” in the first direction “X” is formed with a thin plate part 85 having a plate thickness thinner than that of a portion adjacent to the other side “X2” in the first direction “X”. In this embodiment, the thin plate part 85 is formed in each of end parts 816 and 826 on one side “X1” in the first direction “X” of the second end plate part 81 and the third side plate parts 82. Therefore, the second cover member 8 is formed with a first thin plate part 851 which is the thin plate part 85 formed in the second end plate part 81 and second thin plate parts 852 which are the thin plate parts 85 formed in the third side plate part 82. Accordingly, inner face sides of the second end plate part 81 and the third side plate parts 82 are formed with second step parts 819 and 829 facing one side “X1” in the first direction “X” in a root portion of the thin plate part 85 (first thin plate part 851 and second thin plate parts 852). In this embodiment, the first thin plate part 851 and the second thin plate part 852 are connected with each other. Further, the step part 819 is located on the other side “X2” in the first direction “X” with respect to the step part 829. Therefore, a dimension (width) in the first direction of the first thin plate part 851 is larger than a dimension (width) in the first direction of the second thin plate part 852.

### Manufacturing Method of Geared Motor 1

When the geared motor 1 in this embodiment is to be manufactured, as shown in FIG. 5, the frame 3 is fixed to the motor main body 10 and then, the motor pinion 55 is attached to the motor shaft 50. Further, in a state that the end parts on one side “Z1” in the second direction “Z” of the support shafts 910 and 920 are held by the first plate part 31, the first gear 91 and the second gear 92 are attached to the support shafts 910 and 920, and the first gear 91 and the second gear 92 are engaged with each other, and the first gear 91 and the motor pinion 55 are engaged with each other.

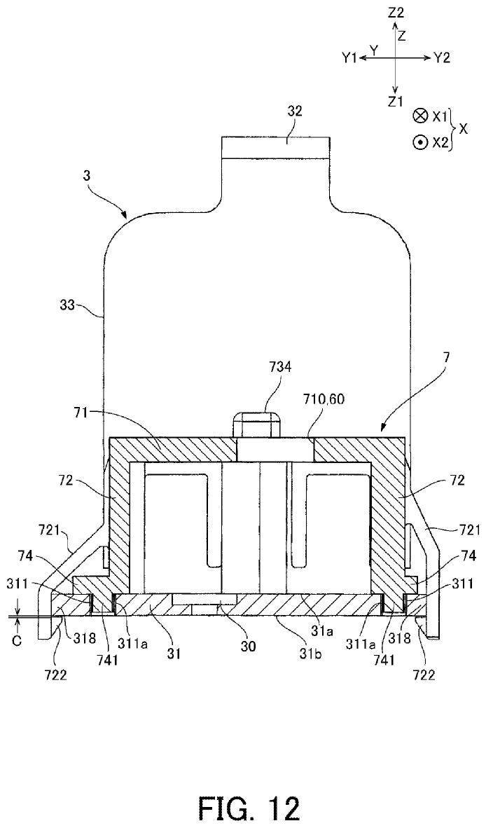

Next, as described below with reference to FIG. 12 and the like, the first cover member 7 is fixed to the frame 3. In this case, the end parts on the one side “Z1” in the second direction “Z” of the support shafts 910 and 920 shown in FIG. 5 are fitted into the shaft holes 713 and 714 of the first cover member 7 (see FIG. 6) and the support shafts 910 and 920 are held.

Next, the rotation center shaft 35 is passed from the hole 37 formed in the second plate part 32 of the frame 3, and the end part 351 (see FIG. 5) on one side “Z1” in the second direction “Z” of the rotation center shaft 35 is fitted into the shaft hole 310 of the first plate part 31, and the end parts 351 and 352 on both sides of the rotation center shaft 35 are respectively fixed to the first plate part 31 and the second plate part 32. In this case, the rotation center shaft 35 is passed into the rotary member 4. Further, the gear part 45 of the rotary member 4 is engaged with the second gear 92.

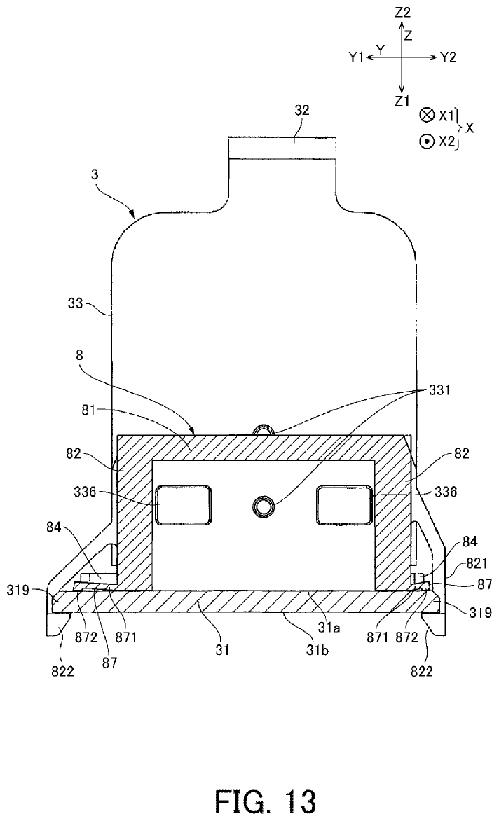

Next, as described below with reference to FIG. 13 and the like, the second cover member 8 is fixed to the first plate part 31 of the frame 3.

### Fixing Structure of First Cover Member 7 to Frame 3

FIG. 12 is a “Y-Z” cross-sectional view showing a state that the gear cover 6 and the like are cut at a position passing through the first protruded parts 741 of the gear cover 6 in the state shown in FIG. 1. In FIG. 12, the motor main body 10, the gear transmission mechanism 9 and the like are not shown.

In this embodiment, when the first cover member 7 is to be fixed to the frame 3, the first cover member 7 is pressed to the third plate part 33 and the first cover member 7 is pressed to the first plate part 31. As a result, the first protruded parts 741 of the first cover member 7 are fitted to the first holes 311 of the first plate part 31, and the first nail parts 722 formed in the first hooks 721 of the first cover member 7 are engaged with the protruded parts 318 on the face 31b on one side “Z2” in the second direction “Z” of the first plate part 31. Further, as shown in FIG. 9, the protruding shaped contact parts 736 of the first flexible plate parts 735 of the gear cover 6 are fitted to inner sides of the opening parts 336 of the third plate part 33. Further, the engagement protruded parts 331 of the third plate part 33 are fitted to the engagement recessed part 731 (see FIG. 8) of the first cover member 7 and thus, an engaging part for positioning the first cover member 7 in the third direction “Y” is structured by using the engagement protruded parts 331 and the engagement recessed part 731. Therefore, the gear cover 6 can be surely positioned in the third direction “Y”. In addition, the two engagement protruded parts 331 formed in the third plate part 33 are fitted to the engagement recessed part 731 formed in a groove shape of the first cover member 7 and thus, an inclination of the first cover member 7 can be restrained.

In this case, as described below, the third plate part 33 of the frame 3 acts as a “first support part” in the present invention and the first plate part 31 acts as a “second support part” in the present invention. Further, the first flexible plate part 735 of the first cover member 7 and the opening part 336 of the third plate part 33 function as an “urging force generation part” in the present invention in which an urging force urging the gear cover 6 in an inclined direction inclined with respect to both of the other side “X2” in the first direction “X” and one side “Z1” in the second direction “Z” is generated. Further, the face 31a facing the other side “Z2” in the second direction “Z” of the first plate part 31 functions as a “first abutting part” in the present invention which abuts with the first cover member 7 from one side “Z1” in the second direction “Z” and, in the inner circumferential surface 311a of the first hole 311 formed in the first plate part 31, a portion located on the other side “X2” in the first direction “X” functions as a “second abutting part” in the present invention which abuts with the first cover member 7 from the other side “X2” in the first direction “X”.

More specifically, in a state shown in the lower figure in FIG. 9, the inclined face 737 of the protruding shaped contact part 736 formed in the first flexible plate part 735 of the first cover member 7 is a contact face of the first cover member 7 with the third plate part 33 and is pressed by the inclined face 337 of the opening edge of the opening part 336 of the third plate part 33 and thereby, the first flexible plate part 735 is resiliently bent to the other side “X2” in the first direction “X”. Therefore, as shown by the arrow “F1” in FIG. 9, the first cover member 7 receives an urging force from the third plate part 33 in an inclined direction inclined with respect to both of the other side “X2” in the first direction “X” and one side “Z1” in the second direction “Z” by a reaction force when the first flexible plate part 735 is resiliently bent. As a result, the face 31a on the other side “Z2” in the second direction “Z” of the first plate part 31 elastically abuts with the gear cover 6 from one side “Z1” in the second direction “Z” as the first abutting part and, in the inner circumferential surface 311a of the first hole 311 formed in the first plate part 31, the portion located on the other side “X2” in the first direction “X” elastically abuts with the first protruded part 741 of the gear cover 6 from the other side “X2” in the first direction “X” as the second abutting part.

In this state, the first nail part 722 of the first hook 721 of the first cover member 7 is engaged with the face 31b on one side “Z1” in the second direction “Z” of the first plate part 31. However, the first hook 721 functions to prevent the gear cover 6 from being detached to the other side “Z2” in the second direction “Z” when a large force is applied to the gear cover 6 and does not participate directly for fixing the first cover member 7 to the frame 3. In other words, the first cover member 7 is formed with the first hook 721 which is elastically engaged with the first plate part 31 and thus, even when a large force is applied to the first cover member 7, the first cover member 7 can be restrained from being detached to the other side “Z2” in the second direction “Z”. Further, the first cover member 7 is fixed by the first flexible plate parts 735, the first plate part 31 (first abutting part) and the first holes 311 and thus, as shown in FIG. 12, even when a clearance “C” between the first nail part 722 of the first hook 721 and the first plate part 31 is large, rattling is hard to occur. Therefore, a large force is not required for engagement of the first hook 721 and thus, assembling work can be performed efficiently.

### Fixing Structure of Second Cover Member 8 to Frame 3

FIG. 13 is a “Y-Z” cross-sectional view showing a state that the second cover member 8 and the like are cut at a position passing the second flexible plate parts 87 of the second cover member 8 in the state shown in FIG. 1. In FIG. 13, the motor main body 10, the gear transmission mechanism 9, the first cover member 7 and the like are not shown.

In this embodiment, when the second cover member 8 is to be fixed to the frame 3, the second cover member 8 is pressed against the first plate part 31. As a result, the second protruded parts 841 of the second cover member 8 are fitted to the second holes 312 of the first plate part 31, and the second nail parts 822 formed in the second hooks 821 of the second cover member 8 are engaged with the protruded parts 319 on the face 31b on one side “Z1” in the second direction “Z” of the first plate part 31. In this case, as shown in FIG. 13, the tip end part 872 of the second flexible plate part 87 formed in the second cover member 8 is abutted with the face 31a on the other side “Z2” in the second direction “Z” of the first plate part 31, and the arm part 871 of the second flexible plate part 87 is resiliently bent to the other side “Z2” in the second direction “Z”. Therefore, the second cover member 8 receives an urging force from the first plate part 31 in a direction separated to the other side “Z2” in the second direction “Z” as shown by the arrow “F2” in FIG. 13 by a reaction force when the second flexible plate part 87 is resiliently bent. As a result, the second nail part 822 of the second hook 821 is elastically engaged with the face 31b on one side “Z1” in the second direction “Z” of the first plate part 31.

### Structure of Boundary Part 61 between First Cover Member 7 and Second Cover Member 8

As shown in FIG. 9, in a state that the first cover member 7 and the second cover member 8 have been fixed to the frame 3, the boundary part 61 between the first cover member 7 and the second cover member 8 in the first direction “X” is structured with an overlapped part 66 where one of the end part 76 on the other side “X2” in the first direction “X” of the first cover member 7 and the end part 86 on one side “Xl” in the first direction “X” of the second cover member 8 is overlapped with the other in a direction perpendicular to the first direction “X”.

In this embodiment, the projected part 75 is formed at the end part 76 on the other side “X2” in the first cover member 7, and the thin plate part 85 is formed at the end part 86 on one side “X1” in the first direction “X” of the second cover member 8. Therefore, in a state that the first cover member 7 and the second cover member 8 have been fixed to the frame 3, the projected part 75 of the first cover member 7 and the thin plate part 85 of the second cover member 8 are overlapped with each other in a direction perpendicular the first direction “X” and the overlapped part 66 is structured. In this embodiment, the projected part 75 is overlapped with the thin plate part 85 from an inner face side of the gear cover 6.

In this embodiment, in a first boundary part 611 of the boundary part 61 which is located between the first end plate part 71 of the first cover member 7 and the second end plate part 81 of the second cover member 8, the first projected part 751 formed in the first end plate part 71 of the first cover member 7 and the first thin plate part 851 formed in the second end plate part 81 of the second cover member 8 are overlapped with each other in the second direction “Z” perpendicular to the first direction “X” to structure a first overlapped part 661. Further, in a second boundary part 612 of the boundary part 61 which is located between the first side plate part 72 of the first cover member 7 and the third side plate part 82 of the second cover member 8, the second projected part 752 formed in the first side plate part 72 of the first cover member 7 and the second thin plate part 852 formed in the third side plate part 82 of the second cover member 8 are overlapped with each other in the third direction “Y” perpendicular to the first direction “X” to structure a second overlapped part 662. Therefore, due to an influence of dimensional accuracy and the like of the first cover member 7 and the second cover member 8, even when a gap space separating the first cover member 7 from the second cover member 8 is occurred in the first direction “X”, the gap space is closed by the overlapped part 66. Accordingly, for example, a situation that the gap space is left in an opened state does not occur, and the gear cover 6 (first cover member 7 and second cover member 8) can be appropriately fixed to the frame 3.

In the geared motor 1 in this embodiment, the boundary part 61 is structured so that the first cover member 7 and the second cover member 8 are positively separated from each other in the first direction “X” through a gap space. More specifically, the first projected part 751 and the second step part 819 are faced each other in the first direction “X” between the first end plate part 71 and the second end plate part 81, but the gap space “G1” is positively provided between the first projected part 751 and the second step part 819. Further, the first step part 719 and the first thin plate part 851 are faced each other in the first direction “X” between the first end plate part 71 and the second end plate part 81, but the gap space “G2” is positively provided between the first step part 719 and the first thin plate part 851. Further, the second projected part 752 and the second step part 829 are faced each other in the first direction “X” between the first side plate part 72 and the third side plate part 82, but the gap space “G3” is positively provided between the second projected part 752 and the second step part 829. Further, the first step part 729 and the second thin plate part 852 are faced each other in the first direction “X” between the first side plate part 72 and the third side plate part 82, but the gap space “G4” is positively provided between the first step part 729 and the second thin plate part 852. Also in this case, in the boundary part 61 between the first cover member 7 and the second cover member 8, the gap spaces “G2” and “G4” facing an outer side are closed by the overlapped part 66 of the first cover member 7 with the second cover member 8.

### Principal Effects in this Embodiment

As described above, in the geared motor 1 in this embodiment, the gear cover 6 includes the first cover member 7 and the second cover member 8, and the first cover member 7 is supported by the third plate part 33 (first support part) and the first plate part 31 (second support part) of the frame 3 (support member), and the second cover member 8 is supported by the second plate part 32 of the frame 3. Therefore, since the first cover member 7 and the second cover member 8 are respectively fixed to the frame 3, even in a case that a single piece of the gear cover 6 is difficult to fix to the frame 3 due to a problem that the rotation center shaft 35 is located at a position where the gear cover 6 is provided, the gear cover 6 can be fixed to the frame 3 easily. Further, in a state that the first cover member 7 and the second cover member 8 have been fixed to the frame 3, even in a case that a gap space separating the first cover member 7 from the second cover member 8 is formed in the first direction “X” due to an influence of dimensional accuracy and the like of the first cover member 7 and the second cover member 8, the overlapped part 66 is provided where one of the end part 76 on the other “X2” side in the first direction “X” of the first cover member 7 and the end part 86 on one side “X1” in the first direction “X” of the second cover member 8 are overlapped with the other in a direction perpendicular to the first direction “X” and thus, for example, a situation that the gap space is left in an opened state does not occur, and the gear cover 6 can be fixed to the frame 3 appropriately. Therefore, entering of a foreign matter to an inner side of the gear cover 6 can be restrained. Further, even in a case that grease or the like is applied to engaging parts of the gear transmission mechanism 9, the grease is hard to leak out to an outer side from the gear cover 6.

Further, in the boundary part 61, the projected part 75 (first projected part 751 and second projected part 752) formed in the first end plate part 71 of the first cover member 7 and the thin plate part 85 (first thin plate part 851 and second thin plate part 852) formed in the second end plate part 81 of the second cover member 8 are overlapped with each other to structure the overlapped part 66 (first overlapped part 661 and second overlapped part 662). Therefore, the overlapped part 66 is structured thinly and the overlapped part 66 does not protrude from an outer face of the gear case 6.

Especially in this embodiment, in the boundary part 61, the first cover member 7 and the second cover member 8 are positively separated from each other in the first direction “X” through the gap spaces “G1”, “G2”, “G3” and “G4”. Therefore, a situation is hard to occur that the first cover member 7 and the second cover member 8 are interfered with each other in the first direction “X” due to an influence of dimensional accuracy and the like of the first cover member 7 and the second cover member 8. Further, even when vibration is transmitted to the gear cover 6, a situation is hard to occur that the first cover member 7 and the second cover member 8 are collided with each other in the first direction “X” to generate noise. Even in this case, the gap spaces “G2” and “G4” facing an outer side in the boundary part 61 between the first cover member 7 and the second cover member 8 are closed by the overlapped part 66 of the first cover member 7 with the second cover member 8 and thus, a foreign matter is hard to enter into the inside of the gear cover 6 through the gap spaces “G2” and “G4”. Further, even in a case that grease or the like is applied to engaging parts of the gear transmission mechanism 9, the grease or the like is hard to leak out to an outer side through the gap spaces “G2” and “G4” of the gear cover 6.

Further, in this embodiment, the first flexible plate part 735 (urging force generation part) is provided which generates an urging force urging the first cover member 7 in an inclined direction inclined with respect to both of the other side “X2” in the first direction “X” and one side “Z1” in the second direction “Z” when the first cover member 7 is pressed against the third plate part 33 in order to fix the first cover member 7 to the frame 3. On the other side, the first plate part 31 is provided with the face 31a (first abutting part) which is elastically abutted with the first cover member 7 from one side “Z1” in the second direction “Z” and the first hole 311 having the inner circumferential surface 311a (second abutting part) which is elastically abutted with the first protruded part 741 of the first cover member 7 from the other side “X2” in the first direction “X”. Therefore, the first cover member 7 can be fixed to the third plate part 33 and the first plate part 31 by a simple operation that the first cover member 7 is pressed toward the third plate part 33 of the frame 3. Further, the first cover member 7 is elastically fixed to the third plate part 33 and the first plate part 31 and thus rattling is hard to occur.

Further, the first flexible plate part 735 is formed with the inclined face 737 so as to face an inclined direction which is inclined with respect to both of one side “X1” in the first direction “X” and the other side “Z2” in the second direction “Z”. Therefore, the urging force generation part can be structured by the first flexible plate part 735 provided in the first cover member 7 in itself and thus, another member for structuring the urging force generation part is not required. Further, the inclined face 737 is formed in the protruding shaped contact part 736 which is protruded from the first flexible plate part 735 toward one side “X1” in the first direction “X” and is abutted with an opening edge (inclined face 737) of the opening part 336 which is opened in the third plate part 33 toward the other side “X2” in the first direction “X”. Therefore, when the first cover member 7 is pressed against the third plate part 33, an urging force which urges the first cover member 7 to an inclined direction inclined with respect to both of the other side “X2” in the first direction “X” and one side “Z1” in the second direction “Z” can be generated surely, and a large gap space can be prevented from occurring between the third plate part 33 and the first cover member 7.

Further, the second abutting part is the inner circumferential surface 311a of the first hole 311 formed in the first plate part 31 so that the first protruded part 741 formed in the gear cover 6 is fitted and thus, the second abutting part can be provided in a simple structure.

Further, in this embodiment, when the second cover member 8 has been fixed to the first plate part 31 of the frame 3 by the second hook 821, the tip end part 872 formed in the second flexible plate part 87 of the second cover member 8 is abutted with the face 31a on the other side “Z1” in the second direction “Z” of the first plate part 31, and the arm part 871 of the second flexible plate part 87 is resiliently bent to the other side “Z2” in the second direction “Z”. Therefore, the second cover member 8 receives an urging force from the first plate part 31 in a direction separated to the other side “Z2” in the second direction “Z” by a reaction force when the second flexible plate part 87 is resiliently bent. As a result, the second nail part 822 of the second hook 821 is elastically engaged with the face 31b on one side “Z1” in the second direction “Z” of the first plate part 31 and thus, rattling is hard to occur between the second cover member 8 and the first plate part 31.

### Other Embodiments

In the embodiment described above, the first flexible plate part 735 (urging force generation part) is formed on a side of the first cover member 7. However, the first flexible plate part 735 may be formed on a side of the third plate part 33 of the frame 3. In the embodiment described above, the second abutting part is structured of the inner circumferential surface of the first hole 311 which is formed to be a through hole. However, the first hole 311 may be formed in a bottomed recessed part. In the embodiment described above, the first protruded part 741 is formed on a side of the first cover member 7. However, it may be structured that the first protruded part 741 is formed on a side of the first plate part 31 of the frame 3 and the first hole 311 formed of a through hole or a bottomed recessed part is formed on a side of the first cover member 7. In this case, the second abutting part is structured of an outer peripheral face of the first protruded part 741. In the embodiment described above, the engagement protruded part 331 is formed on a side of the first plate part 31 of the frame 3. However, it may be structured that the engagement protruded part 331 is formed on a side of the gear cover 6 and the engagement recessed part 731 is formed on a side of the first plate part 31 of the frame 3.

In the embodiment described above, the overlapped part 66 is provided over the entire boundary part 61 between the first cover member 7 and the second cover member 8. However, a structure may be adopted that only one of the first boundary part 611 between the first end plate part 71 and the second end plate part 81 and the second boundary part 612 between the first side plate part 72 and the third side plate part 82 is provided with the overlapped part 66. In the embodiment described above, the projected part 75 of the first cover member 7 is overlapped with the thin plate part 85 of the second cover member 8 from an inner side. However, a structure may be adopted that the projected part 75 of the first cover member 7 is overlapped with the thin plate part 85 of the second cover member 8 from an outer side. In this case, it is preferable that the projected part 75 is formed on an outer face side of the end part 76 of the first cover member 7 and the thin plate part 85 is formed on an inner face side of the end part 86 of the second cover member 8.

In the embodiment described above, the rotation center shaft 35 is a fixed shaft which rotatably supports the rotary member 4. However, the present invention may be applied to a case that the rotation center shaft 35 is a rotary member which is integrally rotated with the rotary member 4.

In the embodiment described above, the structure is mainly described in which the gear cover 6 is fixed to the frame 3 of the geared motor 1. However, the present invention may be applied to a case that a cover is fixed to another support member.

### REFERENCE SIGNS LIST

1 . . . motor, 3 . . . frame (support member), 7 . . . gear cover (cover), 4 . . . rotary member, 9 . . . gear transmission mechanism, 10 . . . motor main body, 31 . . . first plate part (third support part), 31a . . . face (first abutting part), 32 . . . second plate part, 33 . . . third plate part (first support part), 35 . . . rotation center shaft, 50 . . . motor shaft, 55 . . . motor pinion, 60 . . . through hole, 66 . . . overlapped part, 71 . . . first end plate part, 72 . . . first side plate part, 73 . . . second side plate part, 81 . . . second end plate part, 82 . . . third side plate part, 83 . . . fourth side plate part, 87 . . . second flexible plate part, 311 . . . hole, 311a . . . inner circumferential surface (second abutting part), 331 . . . engagement protruded part, 611 . . . first boundary part, 612 . . . second boundary part, 661 . . . first overlapped part, 662 . . . second overlapped part, 710 . . . first cut-out part, 721 . . . first hook, 722 . . . first nail part, 731 . . . engagement recessed part, 735 . . . first flexible plate part (urging force generation part), 736 . . . protruding shaped contact part, 737 . . . inclined face, 741 . . . first protruded part, 810 . . . second cut-out part, 821 . . . second hook, 822 . . . second nail part, “L” . . . motor axial line, “L1” . . . output side, “L2” . . . anti-output side, “X” . . . first direction, “Y” . . . third direction, “Z” . . . second direction, “X1” . . . one side in first direction, “X2” . . . the other side in first direction, “Z1” . . . one side in second direction, “Z2” . . . the other side in second direction

1. A fixing structure of a cover to a support member,
the support member comprising:
a first support part located on one side in a first direction with respect to the cover; and
a second support part located on one side in a second direction perpendicular to the first direction with respect to the cover; and
the cover comprising:
a first cover member supported by the first support part and the second support part; and
a second cover member supported by the second support part on an other side in the first direction with respect to the first cover member;
wherein a boundary part between the first cover member and the second cover member in the first direction comprises an overlapped part where one of an end part on the other side in the first direction of the first cover member and an end part on the one side in the first direction of the second cover member is overlapped with an other of the end part on the other side in the first direction of the first cover member and the end part on the one side in the first direction of the second cover member in a direction perpendicular to the first direction.

2. The fixing structure of a cover according to claim 1, wherein
the end part on the other side in the first direction of the first cover member comprises a projected part which is projected to the other side in the first direction and has a plate thickness thinner than a plate thickness of an adjacent portion to the projected part on the one side in the first direction,
the end part on the one side in the first direction of the second cover member comprises a thin plate part having a plate thickness thinner than a plate thickness of an adjacent portion to the thin plate part on the other side in the first direction, and
the projected part and the thin plate part are overlapped with each other to structure the overlapped part.

3. The fixing structure of a cover according to claim 1, wherein
in the boundary part, the first cover member and the second cover member are separated from each other in the first direction through a gap space, and
the gap space is closed by the overlapped part.

4. The fixing structure of a cover according to claim 1, wherein
one of the first cover member and the support member comprises an urging force generation part structured to generate an urging force urging the cover in an inclined direction which is inclined with respect to both of the other side in the first direction and the one side in the second direction when the first cover member is pressed against the first support part, and
the second support part comprises:
a first abutting part which is abutted with the first cover member from the one side in the second direction; and
a second abutting part which is abutted with e first cover member from the other side in the first direction.

5. The fixing structure of a cover according to claim 4, wherein the urging force generation part is a first flexible plate part structured to be resiliently bent to generate the urging force with an inclined face inclined with respect to both of the first direction and the second direction as a contact face of the first cover member with the first support part when the first cover member is pressed against the first support part.

6. The fixing structure of a cover according to claim 5, wherein
the first flexible plate part is formed in the first cover member so as to extend in the second direction with a free end facing the other side in the second direction,
the first flexible plate part is formed with the inclined face so as to face the inclined direction which is inclined with respect to both of the one side in the first direction and the other side in the second direction, and
the first flexible plate part is resiliently bent to the other side in the first direction to generate the urging force when the first cover member is pressed against the first support part.

7. The fixing structure of a cover according to claim 6, wherein
the inclined face is formed in a protruding shaped contact part which is protruded toward the one side in the first direction from the first flexible plate part,
the first support part is provided with an opening part which is opened toward the other side in the first direction, and
when the first cover member is pressed against the first support part, the protruding shaped contact part is fitted to the opening part, and an opening edge on the other side in the first direction of the opening part is abutted with the inclined face.

8. The fixing structure of a cover according to claim 4, wherein the second abutting part comprises;
an inner circumferential surface of a hole formed in the second support part so that a protruded part formed in the first cover member is fitted; or
an outer peripheral face of a protruded part formed in the second support part so as to be fitted to a hole formed in the first cover member.

9. The fixing structure of a cover according to claim 1, wherein the first cover member comprises a first hook which is protruded toward the other side in the second direction and engaged with the second support part from the one side in the second direction.

10. The fixing structure of a cover according to claim 1, wherein the second cover member comprises:
a second hook which is protruded toward the other side in the second direction and is engaged with the second support part from the one side in the second direction; and
a second flexible plate part which is elastically abutted with the second support part from the other side in the second direction.

11. The fixing structure of a cover according to claim 1, further comprising:
an engagement protruded part which is formed in one of the first support part and the first cover member; and
an engagement recessed part which is formed in an other of the first support part and the first cover member, and the engagement protruded part being fitted to the engagement recessed part, wherein an engaging part positioning the cover in a third direction perpendicular to both of the first direction and the second direction is structured by the engagement protruded part and the engagement recessed part.

12. A geared motor comprising the fixing structure of a cover defined in claim 1, the geared motor comprising:
a motor main body whose a motor axial line is extended toward the other side in the second direction;
a frame comprising:
a first plate part which is fixed to an end part on the other side in the second direction of the motor main body;
a second plate part facing the first plate part on the other side in the second direction; and
a third plate part which connects the first plate part and the second plate part on the one side in the first direction;
a rotary member which is disposed between the first plate part and the second plate part;
a gear transmission mechanism structured to transmit rotation of a motor shaft of the motor main body to the rotary member; and
a gear cover which is fixed to the frame so as to cover the gear transmission mechanism between the first plate part and the second plate part;
wherein the frame is the support member, the gear cover is the cover, the third plate part is the first support part, and the first plate part is the second support part; and
wherein the boundary part comprises a through hole through which a rotation center shaft of the rotary member is penetrated, the through hole being structured of a first cut-out part, which is formed at an end part on the other side in the first direction of a first end plate part of the first cover member facing the first plate part, and a second cut-out part which is formed at an end part on the one side in the first direction of a second end plate part of the second cover member facing the first plate part.

13. The geared motor according to claim 12, wherein the gear transmission mechanism comprises:
a fixed shaft whose both ends are held by the first end plate part and the first plate part; and
a gear rotatably supported by the rotary member.
